(19) United States
(12) Patent Application Publication
(10) Pub. No.: US 2009/0210292 A1
(43) Pub. Date: Aug. 20, 2009

(54) METHOD FOR GENERATING AND CAPTURING CONSUMER OPINIONS ABOUT BRANDS, PRODUCTS, OR CONCEPTS

(76) Inventors: Jens Peder Ammitzboll, Barcelona (ES); Pawel Kobak, Stockholm (SE)

Correspondence Address: BROWDY AND NEIMARK, P.L.L.C.;624 NINTH STREET, NW, SUITE 300, WASHINGTON, DC, 20001-5303, US

(21) Appl. No.: 12/366,001

(22) Filed: Feb. 5, 2009

(30) Foreign Application Priority Data
Feb. 5, 2008 (SE) 0800269-3

(51) Int. Cl. G06Q 10/00; G06Q 90/00

(52) U.S. Cl. 705/10; 705/500

(57) ABSTRACT

The invention is an application for capturing and storing consumer opinions about e.g. brands, products or concepts. The system uses a web-browser interface where a number of pictures, sound-files or video-files is displayed. On the top of the page, a logo, a product or a concept is displayed (the primary stimulus) and users (test persons) are asked to select the picture, or sound-file or video-file that they think has the strongest connection to the primary stimulus. After the user has chosen a picture, a sound-file or a video-file, the user is asked to explain why he/she made this selection and he/his is prompted to this, e.g. with a pop-up window. All the input from the user into the web-browser is stored in a database and e.g. exported automatically to e.g. a worksheet where it can be further analyzed using e.g. chi-square tests and manual coding to identify the most common themes in explanations from users.

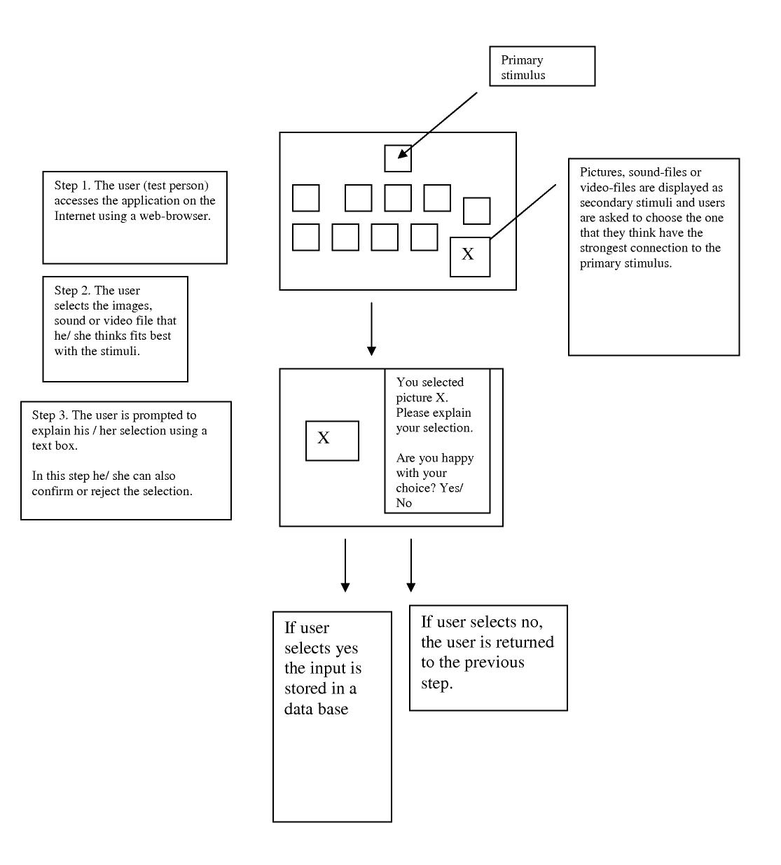

### FIELD OF THE INVENTION

The present invention relates to obtaining market research data, especially via a web-browser, from a group of users, also defined as test persons, such as a panel of consumers or other type of respondents, concerning an object, such as a person or a group of persons, a company, an organization, en event, a concept or similar objects for which market research may be used. When using a web-browser technique the user inputs data are suitably stored in a data base for analysis, such as chi-square analysis and other programmed or manual coding of the input.

### BACKGROUND OF THE INVENTION

Market research firms have increasingly moved research to the Internet where they booth recruit respondents and conduct surveys using various tools for this. This invention brings the so-called image based projective techniques established in the industry of market research and often used in face to face focus groups to the internet, letting users that are recruited via Internet panels ( that are external) participate in image and sound/video-based projective research using a web-browser. To buyers of market research there are several advantages with this.

1. The cost for doing image bases projective research is greatly reduced since there is no need for location, travel and moderators.

2. The lower cost admits for many more test persons (users, respondents) compared to face to face methods which means that samples can easily be made great enough to get statistically significant results and to do global tests.

3. Since no physical person (moderator) is leading the test, there is no influence from the moderator on the responses (input). This is otherwise a common problem in image based projective research in the face to face setting.

4. The data gathering in a database with the selections of the test persons (respondents) and their explanations of their choices, plus complementary questions is stored in a database, (e.g. exported to a work-sheet), where it is easy to segment the respondents and do analysis for different sub-segments, e.g. male/female, users who like the object, e.g. brand, product, concept, that is investigated v.s. respondents who do not like the brand, products, concepts that is investigated.

### SUMMARY OF THE INVENTION

Thus the invention comprises a method for obtaining market research data from a group of test persons (users) by:

a) presenting to the test person of said group at least one primary stimulus representing a feature to which the reaction of the test person is asked for, and

b) presenting to said test person a number of secondary stimuli, and asking the person to state:

c) which of said secondary stimuli he/she believes best represents the primary stimulus, and to give a motivation for the selection of said secondary stimulus, and

d) subjecting the data received from said group of persons to an analysis, suitably by using a data base and/or work-sheet.

The invention also comprises an embodiment of the above described method wherein the presentation of said primary and secondary stimuli is performed with a web-browser interface, said primary and secondary stimuli being selected from the group comprising or consisting of pictures, video files and sound files, and asking the test person to submit his/her reply by input to a data base, and subjecting the replies received from the group of test persons to analysis, especially a computer based analysis.

The invention also comprises a method as mentioned above wherein the primary stimulus and a first group of secondary stimuli are presented simultaneously to the test person on a display, especially with a web-browser display,

the test person is asked to submit his selection of at least one of said secondary stimuli which he/she believes is best representing said primary stimulus, preferably by a mouse click on the display, and

after the test person made said selection, presenting to the test person a second group of secondary stimuli, preferably again together with the primary stimuli, and asking the person to select at least one of said second group stimuli as best representing the primary stimuli.

According to one embodiment of the method the test person after submitting the selection of a secondary stimulus is asked to state by a yes/no choice if he/she maintains the selection, and if selecting yes the input is stored in a data base, whereas if selecting no the test person is returned to a repetition of the selection of the secondary stimuli.

One embodiment comprises that the test person after replying by a selection of a secondary stimulus, especially by an input to a data base, is presented a further time in a further selection sequence, to at least one primary stimuli, especially being the same as or related to the primary stimulus of the preceding selection sequence, together with a second group of secondary stimuli, and repeating the reply procedure of the preceding selection sequence.

This presentation to the test person a further time, in a further sequence, of primary and secondary stimuli with reply input to a data base can also be repeated one or more times, increasing the number of primary and/or secondary stimuli which are presented to the test person.

The secondary stimuli presented for selection together with a primary stimulus may all or partly or mainly belong to one or more of the groups of pictures, video files and sound files resp. Preferably the majority or all of the secondary stimuli presented simultaneously in the same sequence belong to one and the same of said groups. The sound files may preferably be music files.

The primary stimulus may especially comprise a trade mark, picture, name, picture or logotype of at least one person or a group of persons, a company or other organization or an event or a concept, whereas the secondary stimuli comprise at least one picture, video file or sound file which can be regarded, especially by a majority of test persons in a group, as representing the primary stimulus.

The secondary stimuli used in each selection sequence may suitably mainly or all be chosen from one of the secondary stimuli groups wherein the stimuli define “Places”, “Activities”, “Designs”, “Lifestyles”, “Brands” and “Music”.

The number of secondary stimuli shown in each selection sequence is suitably at least 2, e.g. at least 3, at least 4, at least 6, at least 8 or at least 10 and suitably at most 20, at most 15, at most 10 or at most 5, suitably 12. The stimuli are suitably arranged with the primary stimulus at top and the secondary stimuli arranged below in one or more rows, e.g. in 3 rows with 4 stimuli in each row. The display used is suitably a web-browser display or similar means.

### EXAMPLE

The enclosed drawing shows an example of a web-browser display used in the method of the invention together with test procedure steps.

In a test procedure example the test person is first asked on the display to state his/her age and sex and optionally also other personal characteristics that may be of interest for the test, such as domicile, nationality, profession etc., e.g. by introducing the information on the display, e.g. by selecting among alternatives presented on the display.

The enclosed drawing shows an example of a web-browser display with the frames of the primary and secondary stimuli, in this case in a first selection sequence figures (pictures), shown on the display. In this case the figure denoted X is selected as having the strongest connection to the primary stimulus. This selection may e.g. by mouse-click by the test person on said figure be sent to and stored in a data base used in the program. In an optional second selection sequence the primary stimulus is shown on the display together with a new group of secondary stimuli, in this case a number of icons representing sound files, which when activated by a mouse click ply a melody, and the test person is asked to select the melody which he/she believes best represents the primary stimulus, also this selection being sent to and stored in the data base. Optionally this selection sequence may be repeated one or more further times, e.g. with the same primary stimulus and a set of secondary stimuli in the shape of icons which when selected with the mouse show video files. The secondary stimuli presented in the various test sequences may e.g. belong to the stimuli groups which may be defined as comprising activities, designs, lifestyles, brands and music.

Optionally the test person after reporting a selection is asked, e.g. with a pop-up window, to submit a motivation for the selection, e.g. by writing or by selecting with the mouse one out of a number of alternatives presented on the display. All such selections and motivations are suitably sent to and stored in the data base and suitably subjected to analysis, e.g. by using a chi-square test and/or manual coding to identify the most common themes in explanations from the test persons.

The drawing also gives examples of the various steps of the method according to the invention,

Thus, the invention is in a preferred embodiment a method for capturing and storing consumer opinions about brands, products or concepts. The system uses a web-browser interface where a number of pictures, sound-files or video-files is displayed. On the top of the page, a logo, a product or a concept is displayed (the primary stimulus) and users (test persons in a test group or panel) are asked to select the secondary stimulus, e.g. the picture, or sound-file or video-file that they think has the strongest connection to the primary stimulus. After that the user has chosen a secondary stimulus, e.g. a picture, a sound-file or a video-file, the user is asked to explain why he/she made this selection and he/she is prompted to this with a pop-up window. All the input from the user into the web-browser is stored in a data base and exported automatically to a worksheet where it can be further analyzed, e.g. using chi-square tests and manual coding to identify the most common themes in explanations from users.

1. A method for obtaining market research data from a group of test persons comprising:
a) presenting to a test person at least one primary stimulus representing a feature to which the reaction of the test person is asked for, and
b) presenting to said test person a number of secondary stimuli, and asking the person to state:
c) which of said secondary stimuli he/she believes best represents the primary stimulus, and optionally to give a motivation for the selection of said secondary stimulus, and
d) subjecting the data received from said group of test persons to an analysis.

2. A method according to claim 1 wherein the presentation of said primary and secondary stimuli is performed with a web-browser interface, said primary and secondary stimuli being selected from the group consisting of pictures, video files and sound files, and asking the test person to submit his/her reply by input to a data base, and subjecting the replies received from the group of test persons to a computer based analysis.

3. A method according to claim 1 wherein the primary stimulus and a first group of secondary stimuli are presented simultaneously to the test person with a web-browser display,
the test person is asked to submit his selection of at least one of said secondary stimuli as best representing said primary stimulus, and
after receipt of said selection presenting to the test person a second group of secondary stimuli and asking the person to select at least one of said second group as best representing the primary stimuli.

4. A method according to claim 2 wherein the primary stimulus and a first group of secondary stimuli are presented simultaneously to the test person with a web-browser display,
the test person is asked to submit his selection of at least one of said secondary stimuli as best representing said primary stimulus, and
after receipt of said selection presenting to the test person a second group of secondary stimuli and asking the person to select at least one of said second group as best representing the primary stimuli.

5. A method according to claim 1 wherein the test person after submitting the selection of the secondary stimulus is asked to state by a yes/no selection if he maintains the selection, and if selecting yes the input is stored in a data base, whereas if selecting no the test person is returned to a repetition of the selection of the secondary stimuli.

6. A method according to claim 2 wherein the test person after submitting the selection of the secondary stimulus is asked to state by a yes/no selection if he maintains the selection, and if selecting yes the input is stored in a data base, whereas if selecting no the test person is returned to a repetition of the selection of the secondary stimuli.

7. A method according to claim 1 wherein the test person, after replying in a selection of a secondary stimulus by an input to a data base, is presented in a further selection sequence to at least one primary stimulus being at least similar to the primary stimulus of the preceding selection, together with a second group of secondary stimuli, and repeating the reply procedure following the preceding selection sequence.

8. A method according to claim 7 wherein the presentation to the test person a further time of primary and secondary stimuli with reply input to a data base is repeated at least one time.

9. A method according to claim 1 wherein all the secondary stimuli presented for selection together with a primary stimulus in a selection sequence belong to one of the groups of pictures, video files and sound files resp.

10. A method according to claim 1 wherein the primary stimulus is selected from the group consisting of trade marks, names and logotypes of persons, companies and other organizations, and the secondary stimuli comprise at least one stimulus selected from the group consisting of pictures, video files and sound files which can be regarded as representing the primary stimulus.
